(19) United States
(12) Patent Application Publication
(10) Pub. No.: US 2009/0319531 A1
(43) Pub. Date: Dec. 24, 2009

(54) Method and Apparatus for Detecting Devices Having Implementation Characteristics Different from Documented Characteristics

(76) Inventors: Bong Jun Ko, Harrington Park, NJ (US); Kang-Won Lee, Nanuet, NY (US); Vasileios Pappas, Elmsford, NY (US); Dinesh Chandra Verma, New Castle, NY (US)

Correspondence Address: RYAN, MASON & LEWIS, LLP, 90 FOREST AVENUE, LOCUST VALLEY, NY, 11560, US

(21) Appl. No.: 12/142,956

(22) Filed: Jun. 20, 2008

(51) Int. Cl. G06F 17/30

(52) U.S. Cl. 707/10; 707/E17.009

(57) ABSTRACT

Techniques are disclosed for automatically testing for incorrect or incomplete implementation of documented behavior of a device. By way of example, an automated method for checking that one or more devices comply with one or more documented behaviors comprises a computer system performing the following steps. A set of compliance rules is defined for a behavior of at least one of the one or more devices. A set of monitored data is retrieved from the at least one device. The set of monitored data is compared with the set of compliance rules. A result of the comparison is reported.

### FIELD OF THE INVENTION

In general, the present invention is related to network and system management. More specifically, the present invention relates to a computer-implemented method, system, and program product to detect devices whose implementation characteristic is different from the expected behavior documented in standards, contracts, and compliance rules.

### BACKGROUND OF THE INVENTION

In many network and system equipments, it is not unusual to find implementation characteristics that are different from what one would assume from reading the documentation pertaining to that device. As an example, many devices may claim conformance with the specifications of a SNMP (Simple Network Management Protocol) MIB (Management Information Base), either standard or their proprietary one, or their documentation may imply that the device would update some metrics at some memory location. However, the actual implementation may not comply fully with the MIB definition, and the information at that location may not be populated.

As is known, a MIB is a database of objects that can be monitored by a network or system management system. SNMP uses standardized MIB formats that allow any SNMP tools to monitor any device defined by a MIB.

When developing network or system management applications, many existing devices from different vendors typically need to be supported. The situation is exacerbated because the same type of devices from different vendors have different kinds of problems. The deviation between documentation and implementation causes significant problems for developers of systems and network management applications, who often discover the discrepancy at an inopportune time in their development cycle. As a result, the development process takes longer, testing procedure becomes complicated, thereby increasing the cost of the development.

Accordingly, there is a need for a method to automatically test for incorrect or incomplete implementation of documented behavior of a device.

### SUMMARY OF THE INVENTION

Principles of the invention provide techniques for automatically testing for incorrect or incomplete implementation of documented behavior (i.e., characteristic) of a device.

By way of example, in a first embodiment, an automated method for checking that one or more devices comply with one or more documented behaviors comprises a computer system performing the following steps. A set of compliance rules is defined for a behavior of at least one of the one or more devices. A set of monitored data is retrieved from the at least one device. The set of monitored data is compared with the set of compliance rules. A result of the comparison is reported.

The method may further comprise storing the set of compliance rules in a repository. An additional step of the method may further comprise associating each device of the one or more devices with a set of compliance rules. The associating step may further comprise: defining a set of device classes, associating each device with a device class, and associating each device class with a set of compliance rules. Still further, the method may comprise storing the device classes in a repository, storing the associations between devices and device classes in the repository, and storing the associations between the device classes and compliance rules in the repository.

Further, the method may comprise remotely retrieving the set of monitored data from the at least one device through a network connection such as an SNMP. The retrieving step may further comprise remotely retrieving the set of monitored data through a file transfer such as an HTTP or FTP transfer protocol.

Still further, the method may comprise steps of defining a compliance test based on an input signal characteristic of the device, and associating a compliance rule with a compliance test.

The compliance rule may be defined as a type checking rule, a range checking rule, or a data relation rule. The compliance rules may be stored in a database table. The one or more devices may comprise one or more network devices. The monitored data may be from one or more virtual devices comprising a network simulator or a test script. The compliance rules may be automatically deduced from traces or operating behaviors from devices operating in a normal manner.

Similar features may be realized in other embodiments such as an apparatus-based embodiment comprising a memory and processor arrangement, and an article of manufacture-based embodiment comprising a computer readable storage medium.

These and other objects, features and advantages of the present invention will become apparent from the following detailed description of illustrative embodiments thereof, which is to be read in connection with the accompanying drawings.

### BRIEF DESCRIPTION OF THE DRAWINGS

FIG. 1 depicts an automated method for checking that one or more devices comply with one or more documented behaviors/characteristics, according to an embodiment of the invention.

FIG. 2 depicts an association between device classes and compliance rules, according to an embodiment of the invention.

FIG. 3 depicts two examples of data compliance rules represented in a table format, according to an embodiment of the invention.

FIG. 4 depicts an apparatus for checking that one or more devices comply with one or more documented behaviors/characteristics, according to an embodiment of the invention.

FIG. 5 depicts a computer system in accordance with which one or more components/steps of the techniques of the invention may be implemented.

### DETAILED DESCRIPTION

In accordance with principles of the invention, we propose techniques to detect the non-compliant behavior of system and network devices compared to standard or documented behaviors. One important point to note is that we are interested in looking at the information generated by the devices where the information can be used for monitoring and system management. For example, the data we want to validate may be available via SNMP MIBs, web services, ftp, telnet, syslog files, trace file, or any other files or network service.

Our approach to solving the incomplete standards or incorrect implementation is by using the following steps:

(i) Based on the specifications/documentation of the device, a set of compliance rules are developed. These compliance rules define the invariants or constraints that must be satisfied if the device is implemented correctly according to the specifications.

(ii) The compliance rules are rendered in a machine readable structured format, and encoded as such.

(iii) Data obtained from the device is compared to check whether it is satisfying the compliance rules.

The non-satisfaction of compliance rules indicates a deviation between the implementation and the specifications, and is reported as such.

The existing approach to checking for difference in compliance is a series of compliance tests. The compliance tests need to be done before a product is put into operation. They cannot be actively checked when the product is in deployment. Furthermore, the existing approach for checking for compliance for MIB data is usually a manual process, in which a human network manager examines the MIB fields of interest, and ignores the values if she suspects an error, e.g., the value is null.

Using the proposed inventive approach allows for a software system, which can check for noncompliant behavior by devices in an automated manner. This would identify noncompliant behavior significantly faster than the manual process for checking them, and also developers of system and network management applications can test prior to the development of the system. Also, by defining compliance rules for device types (rather than for individual devices), one can reuse the same rule sets in the future compliance checking.

Another advantage of this approach is that the system compliance can be checked even when the product is in active operation and use.

As indicated above, principles of the present invention provide a computer-implemented method, system, and program product for detecting any non-compliant behavior of computer devices, such as network switches/hubs/routers, web servers, file servers, database servers, and the like, compared to the documented behaviors in such sources as the standard, contract, MIB description, product manual, and the like.

For example, if a network router is supposed to report certain types of SNMP MIB fields, then those fields should be correctly populated by the router. However, in practice, the router may not report any value, report a value after a time when data should have been collected, or report an incorrect value. When no value was reported the corresponding field may be simply null, thus no meaningful metric calculation can occur. When a value was reported later than a pre-specified interval, old data will be used by the network management system, hence the metric calculation will be off. When the report value is incorrect there are in general two cases. The first case is a stuck-at fault meaning that the router reports the same value every time, thus the field is stuck at some value. The second case is when it reports some off value, which may be random or related or unrelated to the actual data.

The existing approach in detecting these problems and troubleshooting is done by manual processes by human administrator based on keen observations. In a common scenario, a customized package (or pack) developer may detect some abnormal values in the reported metrics during the debugging of a pack. A pack is a software suite that is developed for a specific set of network devices and for monitoring and creating reports for certain performance and service metrics. When the developer finds that some field does not change when the value should change, for example, the number of transmitted bytes does not change when the system under test should be pumping out packets. Similarly, the developer may detect that some value should be a positive integer, for example, time since last reboot, but it is always zero. Inversely, the developer may detect a certain metric value changes when it should be actually invariant. The developer may also detect the value of some observed metric is out of its nominal range that can be deduced from the relationship with other observed metrics or parameters; for instance, the number of bytes that are transmitted from an interface card exceeding what the physical speed of the interface and link allow.

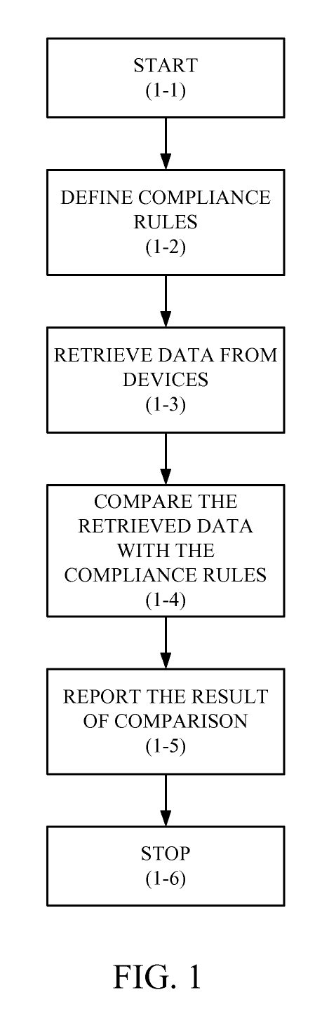

A main idea of the proposed invention is to develop an automated validation and detection mechanism that works based on a simple rule set. With reference to FIG. 1, the operation of the proposed invention can be illustratively described as follows.

The first step (1-1 and 1-2) is to define compliance rules based on the basic understanding of the data field that needs to be collected from the device under test. This can be data type, whether it is invariant or not, range of the value if known, whether it can be null or not. For most data fields, the answers to these questions should be obvious. In order to support a large number of data field types, a preferred embodiment may contain predefined field types for commonly used fields, e.g., Internet Protocol (IP) address, number of bytes, phone number, etc.

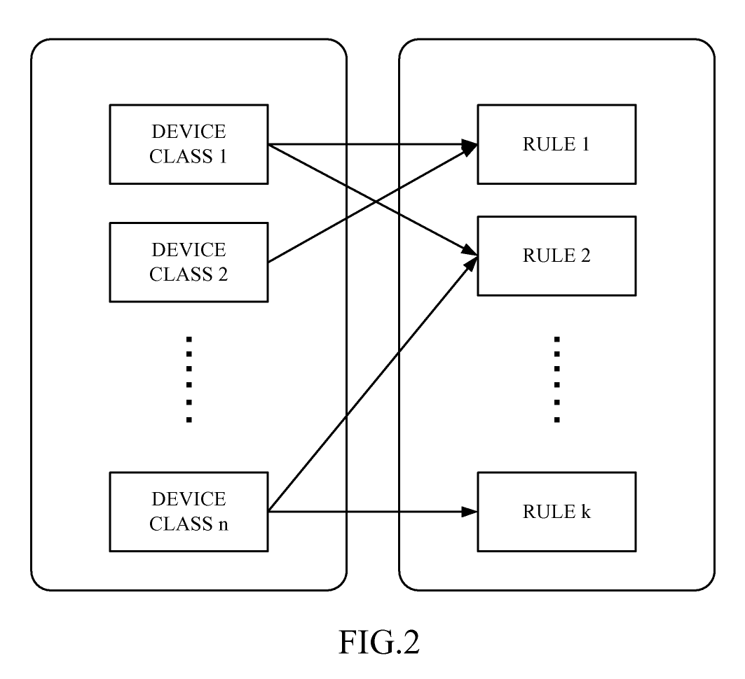

Also, in order to support a large number of device types, a preferred embodiment may classify each individual devices into predefined device classes according to the commonality of different devices (e.g., vendor, device model series, etc.), and associate each device class with a set of predefined compliance rules. This is illustrated in FIG. 2. The definition of device classes and the association of each device class with a set of compliance rules are stored in a repository, so that the compliance rules for individual devices can be composed by retrieving from the repository the predefined set of compliance rules associated with the device class that the device belongs to.

The second step (1-3) of this inventive process is to retrieve data from the network devices. Note that the network devices may be either actual devices that are deployed or simulated devices if this process is used as part of a development process. The data collection can be done via standardized protocols and schemas such as SNMP MIBs, or it could be done via various different protocols and files. For this, networking protocols such as File Transfer Protocol (FTP) or HyperText Transfer Protocol (HTTP) may be used for file retrieval. If the data to collect is available via non-common sources, then a corresponding adapter may be used to retrieve the data. In this case, these adapters can be sources of errors and should be checked if deviated behavior is detected.

The third step (1-4) of our inventive process is to validate the retrieved data using the compliance rules defined in the first step. The data type check and range check can be simply done by comparing the value extracted from the field with the information stored in the compliance rule table. The data relation check can also be easily done by calculating the values and using the relational operators. A straightforward implementation will recompute all the relations for given data values. A more preferred way to implement this function is to store the result of intermediate computation and use them when the same term is needed.

The fourth (1-5) and final step (1-6) is to report any deviation that has been detected in the third step. The reporting can be done by displaying error messages on a console, writing to a log file, or displaying on a dashboard depending on the implementation. However, their functions are essentially the same—to report the difference in the monitored data values and the pre-specified behavior encoded in the rule. After the reporting, an optional step may be added, which is to take corrective action by the human administrator. This can be done by resetting or troubleshooting the problematic network device, monitor, or the adapter module.

As an example of how this system can work, consider a device whose documentation states that it supports a MIB which has the following fields:
A time counter, which measures the time since last boot in microseconds.
A counter which measures how many packets have been sent through the interface since last boot.

If a device is implementing these features to support these parameters, the following is an example of some compliance rules that must be satisfied:
The time counter must be greater than zero.
When the time counter is read after 10 second interval, the difference in two values should approximately be 10,000.
If tested under test conditions test1, the packet counter must be greater than zero and increase at rate of approximately 5 packets per second.
If tested under test conditions test2, the packet counter must remain unchanged.

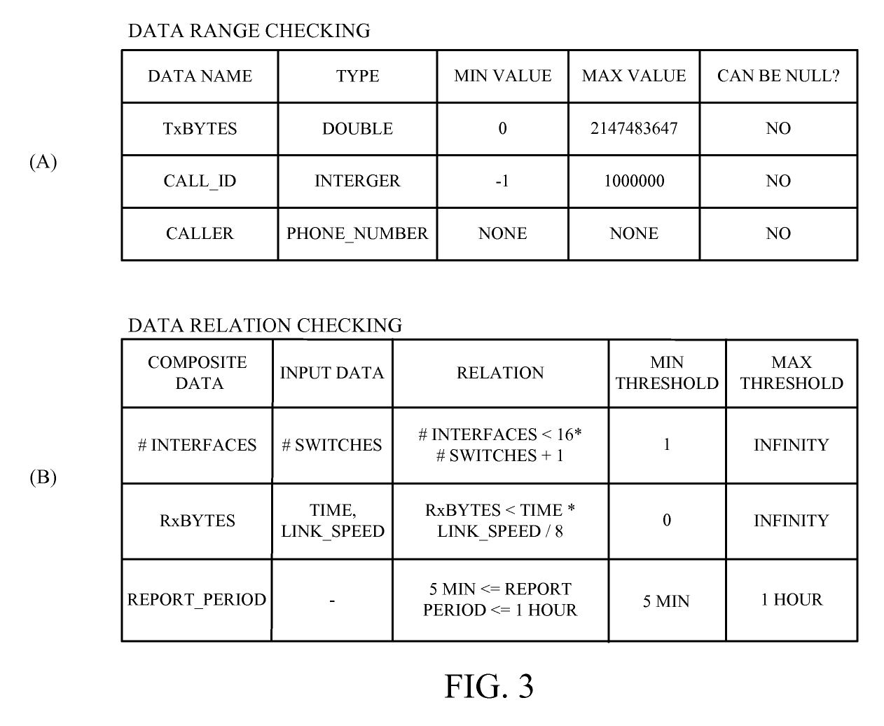

In FIG. 3, we present several examples of how these data compliance rules can be specified. Note that these rules in a table format are for illustration only. In reality, there may be different types of rules and the rules may not be specified in the table format.

The first table (denoted A) shows sample rules that specify the ranges and types of data values. This type of rule is useful in determining whether a particular field value is null or zero, or if a data value is out of range, or if a data type does not match the expected data type. The first row specifies that data collected for TxBytes metric is of type double and has a minimum value of 0 and a maximum value of 2147483647 and it cannot be null. When a value collected for TxBytes violates any of these conditions, it will be caught during the compliance checking of step 3, and will be reported. Similarly, the table contains a rule that says Call_ID should be of integer type with a minimum value −1 and a maximum value 1000000 and cannot be null, and Caller is of phone_number type without any minimum or maximum value.

The second table (denoted B) presents data compliance rules for data relation checking. The main difference of data relation checking rules from the data range checking rules is that the former can specify the relations among more than one data metric values. This type of rule is useful in detecting if a certain condition is not satisfied, or if a data value is growing at a rate that is out of range. For example, the first rule represents the constraints placed on a data metric called #interfaces with respect to a metric called #switches. In particular, these metrics have the relation of:
#interfaces <16*#switches+1.

The min threshold specifies the minimum value of #interfaces metric and the max threshold specifies the maximum value of #interfaces.

Similarly, the second rule specifies the relationship between RxBytes and metrics called time and link_speed as follows:
RxBytes <time*link_speed/8.

For RxBytes, there is the minimum value is 0 and the maximum value is not determined.

Finally, the rule for Report_metric is essentially the same as the data range checking. We present this as another way to specify data range.

There are other types of rules that are important in network/system monitoring. One such rule is the direction of change of data value. For example, if a data metric measures the number of seconds since reboot, it should monotonically increase. If this data value decreases for certain period of time, we can suspect there is an error. Conversely, if some metric should always decrease, we can detect reporting error when it increases for certain period. Also, another condition to check is if a value has never changed for a long time. This may indicate a stuck-at fault. Conversely, some values are invariants and they should never change. If these values change, then that will be also detected.

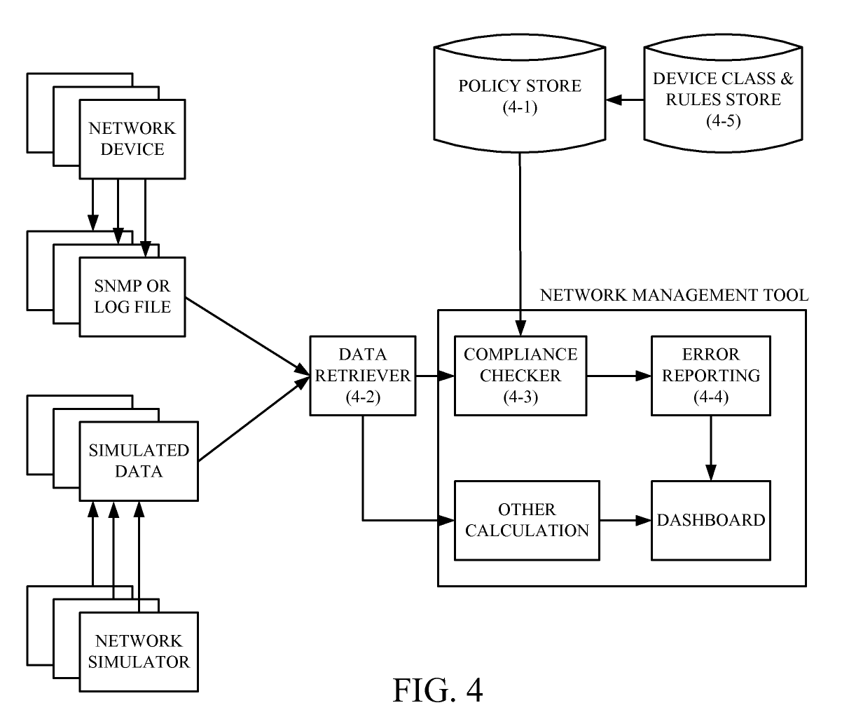

FIG. 4 presents a diagram of an apparatus that implements the proposed inventive method. The apparatus comprises the following components.

(i) A policy store (4-1), which stores the compliance rules in a machine readable format, e.g., as a relational database table, Extensible Markup Language (XML) document according to a defined schema, or in a rule specification language like Common Information Model—Simplified Policy Language (CIM-SPL).

(ii) One or more data retrievers (4-2), which are used to obtain the SNMP MIB data entries from a datastore (e.g., an SNMP MIB or a database) and poll them periodically, or generic data from log files of the network devices through adaptors. Simulated data from a network simulator can also be retrieved by the data retrievers.

(iii) A compliance checker (4-3), which validates that the compliance rules are obeyed for the data obtained by the data retriever.

(iv) An error reporting module (4-4), which is invoked when the compliance checker finds a violation, and is used to identify the MIB entry which is not being updated as expected. The result of the error reporting module can be either displayed on the dashboard, on the console, or written in a log file.

(v) A repository (4-5) that stores a set of predefined device classes, a set of predefined compliance rules, and the association between device classes and sets of compliance rules (e.g., as depicted in FIG. 2).

We note that this system can be run against devices that are in production, as well as systems in the labs used for testing (e.g., simulated devices).

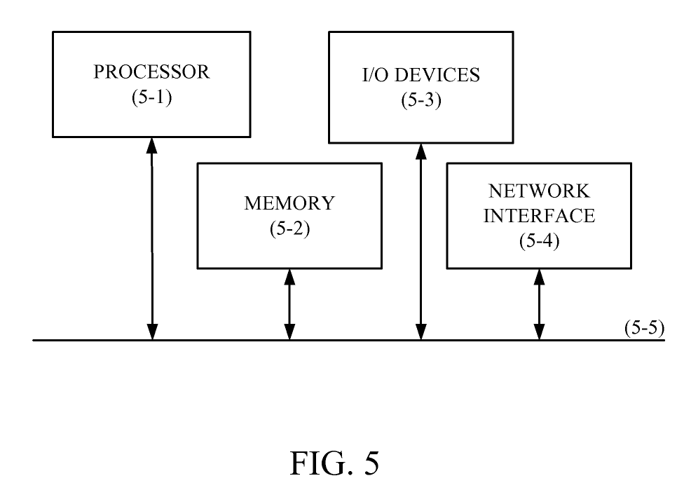

Lastly, FIG. 5 illustrates a computer system in accordance with which one or more components/steps of the techniques of the invention may be implemented. It is to be further understood that the individual components/steps may be implemented on one such computer system or on more than one such computer system. In the case of an implementation on a distributed computing system, the individual computer systems and/or devices may be connected via a suitable network, e.g., the Internet or World Wide Web. However, the system may be realized via private or local networks. In any case, the invention is not limited to any particular network.

Thus, the computer system shown in FIG. 5 may represent one or more servers or one or more other processing devices capable of providing all or portions of the functions described herein. Alternatively, FIG. 5 may represent a mainframe computer system.

The computer system may generally include a processor (5-1), memory (5-2), input/output (I/O) devices (5-3), and network interface (5-4), coupled via a computer bus (5-5) or alternate connection arrangement.

It is to be appreciated that the term “processor” as used herein is intended to include any processing device, such as, for example, one that includes a CPU and/or other processing circuitry. It is also to be understood that the term “processor” may refer to more than one processing device and that various elements associated with a processing device may be shared by other processing devices.

The term “memory” as used herein is intended to include memory associated with a processor or CPU, such as, for example, RAM, ROM, a fixed memory device (e.g., hard disk drive), a removable memory device (e.g., diskette), flash memory, etc. The memory may be considered a computer readable storage medium which, with one or more computer-executable programs including instruction code capable of performing steps of the inventive methodologies stored thereon, is considered an article of manufacture.

In addition, the phrase “input/output devices” or “I/O devices” as used herein is intended to include, for example, one or more input devices (e.g., keyboard, mouse, etc.) for entering data to the processing unit, and/or one or more output devices (e.g., display, etc.) for presenting results associated with the processing unit.

Still further, the phrase “network interface” as used herein is intended to include, for example, one or more transceivers to permit the computer system to communicate with another computer system via an appropriate communications protocol.

Accordingly, software components including instructions or code for performing the methodologies described herein may be stored in one or more of the associated memory devices (e.g., ROM, fixed or removable memory) and, when ready to be utilized, loaded in part or in whole (e.g., into RAM) and executed by a CPU.

In any case, it is to be appreciated that the techniques of the invention, described herein and shown in the appended figures, may be implemented in various forms of hardware, software, or combinations thereof, e.g., one or more operatively programmed general purpose digital computers with associated memory, implementation-specific integrated circuit(s), functional circuitry, etc. Given the techniques of the invention provided herein, one of ordinary skill in the art will be able to contemplate other implementations of the techniques of the invention.

Although illustrative embodiments of the present invention have been described herein with reference to the accompanying drawings, it is to be understood that the invention is not limited to those precise embodiments, and that various other changes and modifications may be made by one skilled in the art without departing from the scope or spirit of the invention.

What is claimed is:

1. An automated method for checking that one or more devices comply with one or more documented behaviors, comprising a computer system performing steps of:
defining a set of compliance rules for a behavior of at least one of the one or more devices;
retrieving a set of monitored data from the at least one device;
comparing the set of monitored data with the set of compliance rules; and
reporting a result of the comparison.

2. The method of claim 1, further comprising a step of storing the set of compliance rules in a repository.

3. The method of claim 1, further comprising a step of associating each device of the one or more devices with a set of compliance rules.

4. The method of claim 3, wherein the associating step further comprises steps of:
defining a set of device classes;
associating each device with a device class; and
associating each device class with a set of compliance rules.

5. The method of claim 4, further comprising steps of:
storing the device classes in a repository;
storing the associations between devices and device classes in the repository; and
storing the associations between the device classes and compliance rules in the repository.

6. The method of claim 1, further comprising a step of remotely retrieving the set of monitored data from the at least one device through a network connection.

7. The method of claim 6, wherein the remote retrieving step further comprises the step of remotely retrieving the set of monitored data through a Simple Network Management Protocol.

8. The method of claim 6, wherein the remote retrieving step further comprises the step of remotely retrieving the set of monitored data through a file transfer.

9. The method of claim 8, wherein the remote retrieving step further comprises the step of remotely retrieving the set of monitored data with the use of a HyperText Transfer Protocol or a File Transfer Protocol.

10. The method of claim 1, further comprising steps of:
defining a compliance test based on an input signal characteristic of the device; and
associating a compliance rule with a compliance test.

11. The method of claim 1, further comprising a step of defining a compliance rule as a type checking rule.

12. The method of claim 1, further comprising a step of defining a compliance rule as a range checking rule.

13. The method of claim 1, further comprising a step of defining a compliance rule as a data relation rule.

14. The method of claim 1, further comprising a step of defining the compliance rules in a database table.

15. The method of claim 1, wherein the one or more devices comprise one or more network devices.

16. The method of claim 1, wherein the monitored data is from one or more virtual devices comprising a network simulator or a test script.

17. The method of claim 1, wherein the compliance rules are automatically deduced from traces or operating behaviors from devices operating in a normal manner.

18. Apparatus for checking that one or more devices comply with one or more documented behaviors, comprising:
a memory; and
a processor operatively coupled to the memory and configured to: define a set of compliance rules for a behavior of at least one of the one or more devices; retrieve a set of monitored data from the at least one device; compare the set of monitored data with the set of compliance rules; and report a result of the comparison.

19. The apparatus of claim 1, further comprising a step of associating each device of the one or more devices with a set of compliance rules.

20. An article of manufacture for checking that one or more devices comply with one or more documented behaviors, the article comprising a computer readable storage medium including one or more programs which when executed by a computer system perform the steps of:
defining a set of compliance rules for a behavior of at least one of the one or more devices;
retrieving a set of monitored data from the at least one device;
comparing the set of monitored data with the set of compliance rules; and
reporting a result of the comparison.
